(19) United States
(12) Patent Application Publication
(10) Pub. No.: US 2026/0163809 A1
(43) Pub. Date: Jun. 11, 2026

(54) METHOD AND DEVICE FOR TRANSMITTING INFORMATION, AND METHOD AND DEVICE FOR RECEIVING INFORMATION

(71) Applicants: LG ELECTRONICS INC., Seoul (KR); THE UNIVERSITY OF HONG KONG, Hong Kong (CN)

(72) Inventors: Kijun JEON, Seoul (KR); Kaibin HUANG, Hong Kong (CN); Qunsong ZENG, Hong Kong (CN); Sangrim LEE, Seoul (KR)

(73) Assignees: LG ELECTRONICS INC., Seoul (KR); THE UNIVERSITY OF HONG KONG, Hong Kong (CN)

(21) Appl. No.: 18/704,544

(22) PCT Filed: Nov. 17, 2021
(86) PCT No.: PCT/KR2021/016865

§ 371 Date: Apr. 25, 2024

(51) Int. Cl. H04L 41/16; H04B 17/318; H04L 5/00

(52) U.S. Cl. CPC H04L 41/16; H04B 17/328; H04L 5/0051

(57) ABSTRACT

The present method relates to a method by which a base station receives a signal in a communication system and to a device therefor, the method comprising the steps of: receiving a reference signal from a terminal; estimating, on the basis of the reference signal, channel quality of the terminal; estimating, on the basis of the channel quality of the terminal, a power margin available from the terminal for neural network learning in a round of federated learning; and requesting, on the basis of the estimated power margin being greater than or equal to a reference value, a neural network learning result for the round from the terminal, wherein the round includes a calculation period for calculating the neural network learning result and a communication period for reporting the neural network learning result.

### TECHNICAL FIELD

The disclosure relates to a communication system, and more particularly, to a method and apparatus for transmitting/receiving information. Specifically, the disclosure relates to a method and device for scheduling and local computation control, for energy-efficient federated learning.

### BACKGROUND ART

Wireless communication systems have been widely deployed to provide various types of communication services such as voice and data, and attempts to incorporate artificial intelligence (AI) into communication systems are rapidly increasing. AI integration methods may be largely categorized into communications for AI (C4AI), which develops communication technology to support AI, and AI for communications (AI4C), which utilizes AI to improve communication performance. In the AI4C area, there are attempts to increase design efficiency by replacing a channel encoder/decoder with an end-to-end autoencoder. In the C4AI area, there is a method of updating a common prediction model, while protecting personal information by sharing only the weights or gradients of an AI model with a server without sharing raw data, using a distributed learning technique, federated learning. Additionally, there is a method of distributing the loads of a device, a network edge, and a cloud server by using split inference.

### DISCLOSURE

### Technical Problem

An objective of the disclosure is to provide a method and device for efficiently performing federated learning. Further, an objective of the disclosure is provide a method and apparatus for scheduling and/or local computation control, for energy-efficient federated learning.

It will be appreciated by persons skilled in the art that the objects that could be achieved with the disclosure are not limited to what has been particularly described hereinabove and the above and other objects that the disclosure could achieve will be more clearly understood from the following detailed description of the disclosure.

### Technical Solution

According to a first aspect of the disclosure, a method of receiving a signal by a base station (BS) in a wireless communication system is provided, including receiving a reference signal from a user equipment (UE), estimating channel quality of the UE based on the reference signal, estimating a power margin available for a neural network learning at the UE within a round for federated learning, based on the channel quality of the UE, and requesting, to the UE, a result of the neural network learning for the round, based on the estimated power margin being equal to or greater than a threshold. The round includes a computation period for the result of the neural network learning and a communication period for reporting the result of the neural network learning.

According to a second aspect of the disclosure, a BS used in a wireless communication system is provided, including at least one radio frequency (RF) unit, at least one processor, and at least one computer memory operably connected to the at least one processor, and when executed, causing the at least one processor to perform operations. The operations include receiving a reference signal from a UE, estimating channel quality of the UE based on the reference signal, estimating a power margin available for a neural network learning at the UE within a round for federated learning, based on the channel quality of the UE, and requesting, to the UE, a result of the neural network learning for the round, based on the estimated power margin being equal to or greater than a threshold. The round includes a computation period for the result of the neural network learning and a communication period for reporting the result of the neural network learning.

According to a third aspect of the disclosure, an apparatus used in a BS is provided, including at least one processor, and at least one computer memory operably connected to the at least one processor, and when executed, causing the at least one processor to perform operations. The operations include receiving a reference signal from a UE, estimating channel quality of the UE based on the reference signal, estimating a power margin available for a neural network learning at the UE within a round for federated learning, based on the channel quality of the UE, and requesting, to the UE, a result of the neural network learning for the round, based on the estimated power margin being equal to or greater than a threshold. The round includes a computation period for the result of the neural network learning and a communication period for reporting the result of the neural network learning.

According to a fourth aspect of the disclosure, a computer-readable storage medium is provided, including at least one computer program which when executed, causes at least one processor to perform operations. The operations include receiving a reference signal from a UE, estimating channel quality of the UE based on the reference signal, estimating a power margin available for a neural network learning at the UE within a round for federated learning, based on the channel quality of the UE, and requesting, to the UE, a result of the neural network learning for the round, based on the estimated power margin being equal to or greater than a threshold. The round includes a computation period for the result of the neural network learning and a communication period for reporting the result of the neural network learning.

Preferably, the power margin may be further determined based on (1) an energy budget for the round and (2) a length of the communication period in the round.

Preferably, a mini-batch size related to the result of the neural network learning may be determined based on a length of the computation period in the round and a per-sample workload.

Preferably, requesting, to the UE, a result of the neural network learning for the round may be skipped based on the estimated power margin being less than the threshold.

### Advantageous Effects

According to embodiment(s) of the disclosure, federated learning may be efficiently performed. Further, the disclosure may provide a method and apparatus for scheduling and/or local computation control, for energy-efficient federated learning.

It will be appreciated by persons skilled in the art that the effects that may be achieved with the disclosure are not limited to what has been particularly described hereinabove and other advantages of the disclosure will be more clearly understood from the following detailed description taken in conjunction with the accompanying drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 illustrates physical channels used in a 3rd generation partnership project (3GPP) system as an exemplary wireless communication systems and a general signal transmission method using the same.

FIG. 2 illustrates a radio frame structure.

FIG. 3 illustrates a resource grid of a slot.

FIG. 4 illustrates mapping of physical channels in a slot.

FIG. 5 illustrates a PDSCH transmission procedure.

FIG. 6 illustrates an exemplary PUSCH transmission procedure.

FIG. 7 illustrates an exemplary neural network learning process.

FIG. 8 illustrates an exemplary federated learning system.

FIG. 9 illustrates an exemplary operation of an edge device.

FIG. 10 illustrates a scheduling method according to an embodiment of the disclosure.

FIG. 11 illustrates an exemplary transmission and reception process according to an embodiment of the disclosure.

FIGS. 12 to 15 illustrate an example of a communication system 1 and wireless devices which are applied to the disclosure.

### MODE FOR INVENTION

Embodiments of the disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive machine type communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (cMBB), massive MTC, and ultra-reliable and low latency communication (URLLC) is being discussed. In the disclosure, for simplicity, this technology will be referred to as NR (New Radio or New RAT).

For the sake of clarity, 3GPP NR is mainly described, but the technical idea of the disclosure is not limited thereto.

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

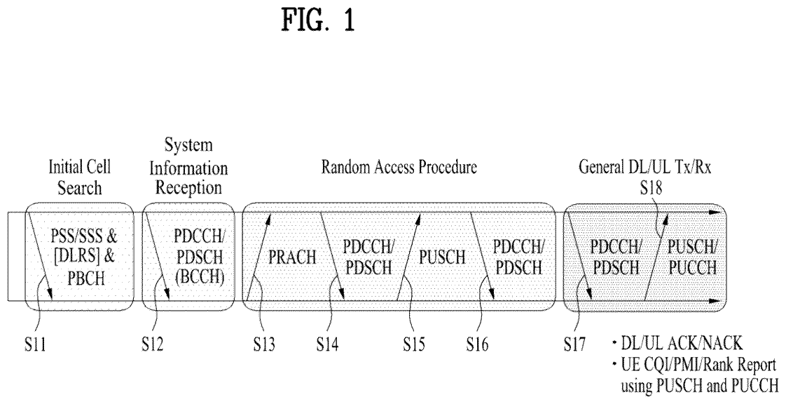

FIG. 1 illustrates physical channels used in a 3GPP NR system and a general signal transmission method using the same.

When powered on or when a UE initially enters a cell, the UE performs initial cell search involving synchronization with a BS in step S101. For initial cell search, the UE receives synchronization signal block (SSB). The SSB includes a primary synchronization signal (PSS), a secondary synchronization signal (SSS), and a physical broadcast channel (PBCH). The UE synchronizes with the BS and acquires information such as a cell Identifier (ID) based on the PSS/SSS. Then the UE may receive broadcast information from the cell on the PBCH. In the meantime, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

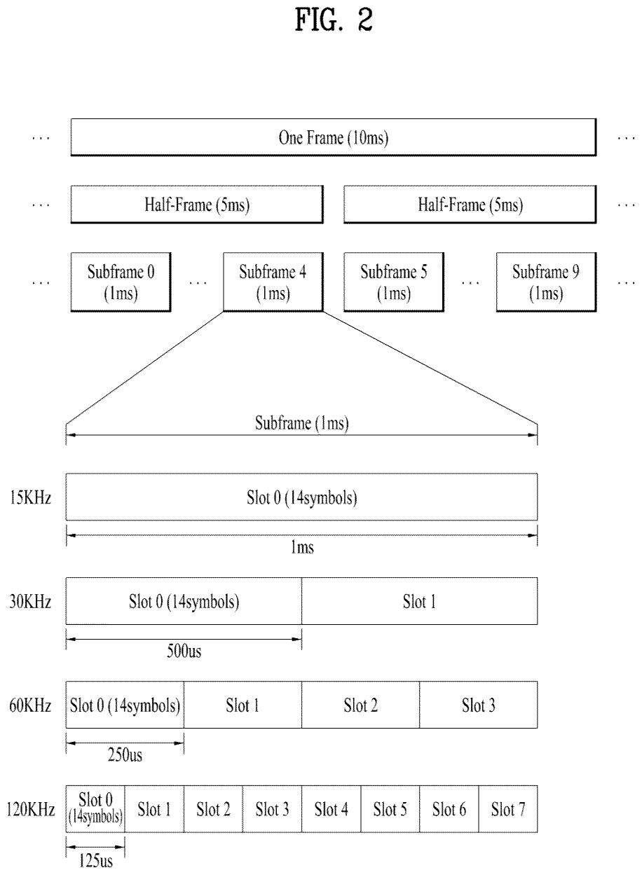

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 orthogonal frequency division multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

*N^{slot}_{symb}: Number of symbols in a slot
*N^{frame, u}ₛₗₒₜ: Number of slots in a frame
*N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The frame structure is merely an example. The number of subframes, the number of slots, and the number of symbols in a frame may vary.

In the NR system, different OFDM numerologies (e.g., SCSs) may be configured for a plurality of cells aggregated for one UE. Accordingly, the (absolute time) duration of a time resource including the same number of symbols (e.g., a subframe (SF), slot, or TTI) (collectively referred to as a time unit (TU) for convenience) may be configured to be different for the aggregated cells. A symbol may be an OFDM symbol (or CP-OFDM symbol) or an SC_FDMA symbol (or a discrete Fourier transform-spread-OFDM (DFT-s-OFDM) symbol).

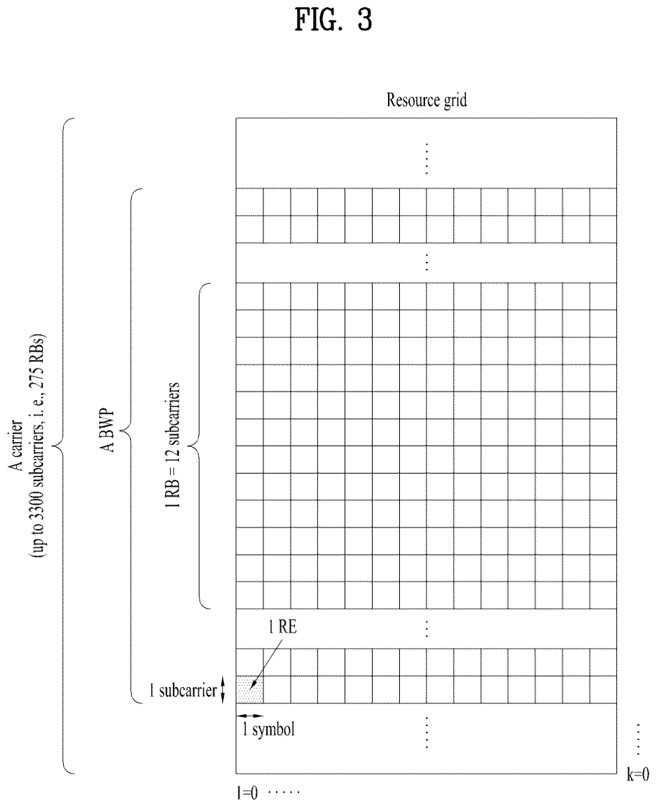

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

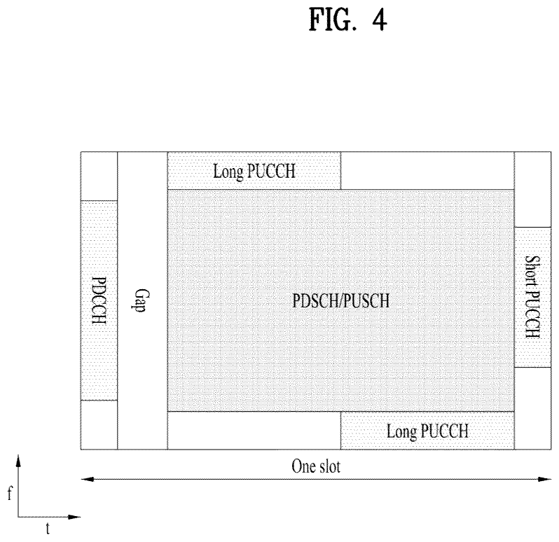

FIG. 4 illustrates exemplary mapping of physical channels in a slot. In the NR system, a frame is characterized by a self-contained structure in which all of a DL control channel, DL or UL data, and a UL control channel may be included in one slot. For example, the first N symbols of a slot may be used for a DL control channel (e.g., PDCCH) (hereinafter, referred to as a DL control region), and the last M symbols of the slot may be used for a UL control channel (e.g., PUCCH) (hereinafter, referred to as a UL control region). Each of N and M is an integer equal to or larger than 0. A resource area (referred to as a data region) between the DL control region and the UL control region may be used for transmission of DL data (e.g., PDSCH) or UL data (e.g., PUSCH). A guard period (GP) provides a time gap for switching between a transmission mode and a reception mode at the BS and the UE. Some symbol at the time of switching from DL to UL may be configured as a GP.

The PDCCH carries downlink control information (DCI). For example, the PCCCH (i.e., DCI) carries a transmission format and resource allocation of a downlink shared channel (DL-SCH), resource allocation information about an uplink shared channel (UL-SCH), paging information about a paging channel (PCH), system information present on the DL-SCH, resource allocation information about a higher layer control message such as a random access response transmitted on a PDSCH, a transmit power control command, and activation/release of configured scheduling (CS). The DCI includes a cyclic redundancy check (CRC). The CRC is masked/scrambled with different identifiers (e.g., radio network temporary identifier (RNTI)) according to the owner or usage of the PDCCH. For example, if the PDCCH is for a specific UE, the CRC will be masked with a UE identifier (e.g., cell-RNTI (C-RNTI)). If the PDCCH is for paging, the CRC will be masked with a paging-RNTI (P-RNTI). If the PDCCH is for system information (e.g., a system information block (SIB)), the CRC will be masked with a system information RNTI (SI-RNTI). If the PDCCH is for a random access response, the CRC will be masked with a random access-RNTI (RA-RNTI).

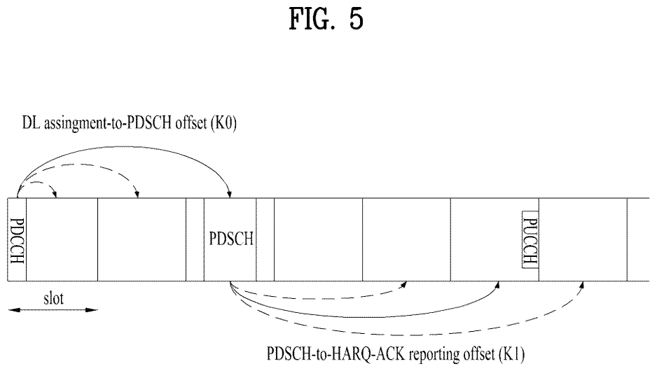

FIG. 5 illustrates an PDSCH transmission procedure. Referring to FIG. 5, the UE may detect a PDCCH in slot #n. Here, the PDCCH includes downlink scheduling information (e.g., DCI format 1_0 or 1_1). The PDCCH indicates a DL assignment-to-PDSCH offset (K0) and a PDSCH-HARQ-ACK reporting offset (K1). For example, DCI format 1_0 or 1_1 may include the following information.
Frequency domain resource assignment: Indicates an RB set assigned to the PDSCH.
Time domain resource assignment: Indicates K0 and the starting position (e.g. OFDM symbol index) and duration (e.g. the number of OFDM symbols) of the PDSCH in a slot.
PDSCH-to-HARQ_feedback timing indicator: Indicates K1.
HARQ process number (4 bits): Indicates an HARQ process identify (ID) for data (e.g., PDSCH or TB).
PUCCH resource indicator (PRI): Indicates PUCCH resources to be used for UCI transmission among a plurality of resources in a PUCCH resource set.

After receiving the PDSCH in slot #(n+K0) according to the scheduling information of slot #n, the UE may transmit UCI on the PUCCH in slot #(n+K1). Here, the UCI includes a HARQ-ACK response to the PDSCH. In the case where the PDSCH is configured to transmit a maximum of one TB, the HARQ-ACK response may be configured in one bit. In the case where the PDSCH is configured to transmit a maximum of two TBs, the HARQ-ACK response may be configured in two bits if spatial bundling is not configured and may be configured in one bit if spatial bundling is configured. When slot #(n+K1) is designated as a HARQ-ACK transmission time for a plurality of PDSCHs, the UCI transmitted in slot #(n+K1) includes HARQ-ACK responses to the plurality of PDSCHs.

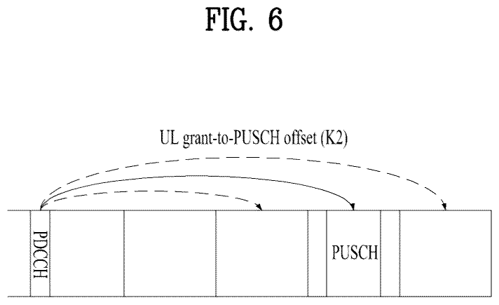

FIG. 6 illustrates an exemplary PUSCH transmission procedure. Referring to FIG. 6, a UE may detect a PDCCH in slot #n. The PDCCH may include UL scheduling information (e.g., DCI format 0_0, DCI format 0_1). DCI format 0_0 and DCI format 0_1 may include the following information.
Frequency domain resource assignment: this indicates an RB set allocated to a PUSCH.
Time domain resource assignment: this specifies a slot offset K2 indicating the starting position (e.g., symbol index) and length (e.g., the number of OFDM symbols) of the PUSCH in a slot. The starting symbol and length of the PUSCH may be indicated by a SLIV, or separately.

The UE may then transmit the PUSCH in slot #(n+K2) according to the scheduling information in slot #n. The PUSCH includes a UL-SCH TB. When the PUCCH transmission time overlaps with the PUSCH transmission time, UCI may be transmitted on the PUSCH (PUSCH piggyback).

### Embodiment

The 3GPP has worked on standardization of a 5G system called new RAT (hereafter, NR), and discussion is underway on a 6G system as a successor to the 5G system.

The 6G system is aimed at (i) very high data rates per device, (ii) a very large number of connected devices, (iii) global connectivity, (iv) very low latency, (v) lower energy consumption for battery-free IoT devices, (vi) ultra-reliable connectivity, and (vii) connected intelligence with machine learning capabilities. The vision of the 6G system may be four aspects such as intelligent connectivity, deep connectivity, holographic connectivity, and ubiquitous connectivity, and the 6G system may fulfill the requirements as listed in Table 3.

TABLE 3

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

One of new techniques that will be introduced in the 6G system is artificial intelligence (AI). The 4G system does not involve AI, and the 5G system will have partial or very limited AI support. However, in the 6G system, AI may be fully supported for automation. Advances in machine learning will create a more intelligent network for real-time communications in 6G. The introduction of AI in communications may streamline and improve real-time data transmission. AI may use numerous analytics to determine how complex target tasks are to be performed. Time-consuming tasks such as handover, network selection, and resource scheduling may be performed instantly by using AI. AI may also play an important role in M2M, machine-to-human, and human-to-machine communications.

Although there have been attempts to integrate AI with wireless communication systems in recent years, these attempts have focused on the application layer and the network layer, especially on combining deep learning with the field of wireless resource management and allocation. However, the research is increasingly evolving to the MAC layer and the physical layer. Particularly, attempts are made to combine deep learning with wireless transmission at the physical layer. AI-based physical layer transmission means that the underlying signal processing and communication mechanisms are based on AI drivers rather than traditional communication frameworks. For example, it may include deep learning-based channel coding and decoding, deep learning-based signal estimation and detection, a deep learning-based MIMO mechanism, AI-based resource scheduling and allocation, and so on.

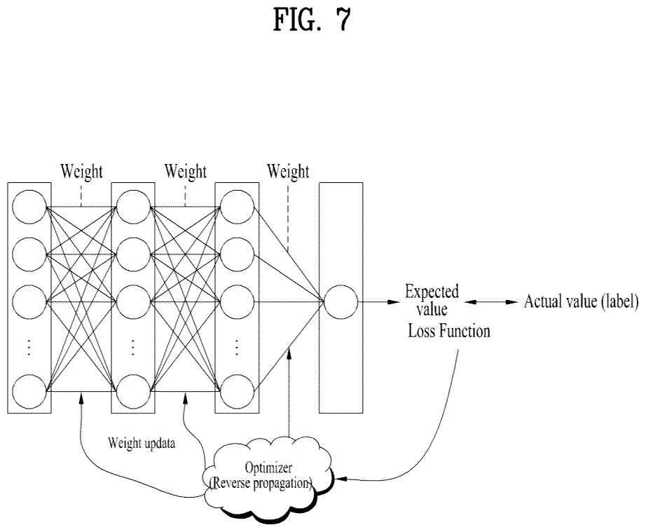

FIG. 7 illustrates an exemplary machine learning process based on a neural network (NN). In general, the machine learning process may be performed as follows: (1) constructing a model by selecting an algorithm suitable for a problem to be solved, (2) training the model with training data, and (3) validating the model with test data. Training the model with training data involves calculating parameters (e.g., weights and gradients) of each layer that makes up an AI NN (simply, NN). Referring to FIG. 7, the model may be trained by comparing a predicted value of the NN with an actual value (e.g., label) and updating a weight of the NN in a manner that minimizes an error between the predicted value and the actual value. The error between the predicted value and the actual value is calculated using a loss function, and the weight may be updated through a reverse propagation process based on the loss function. A reverse propagation algorithm used in the NN is divided into a forward path which involves calculating weights of each layer from an input to an output, and a reverse path which involves modifying the existing weight through the calculation process again, going backward in the opposite direction of the forward path. Once the forward/reverse path process is completed for entire data, it may be said that the model has been completely trained, and the model may be validated using the weights of each layer calculated so far. The weights may be calculated based on gradients.

In recent years, there has been an increasing demand for a federated edge learning (FEEL) use case in which datasets collected by edge devices (e.g., smartphones or sensors) are used to train an AI model at a network edge.

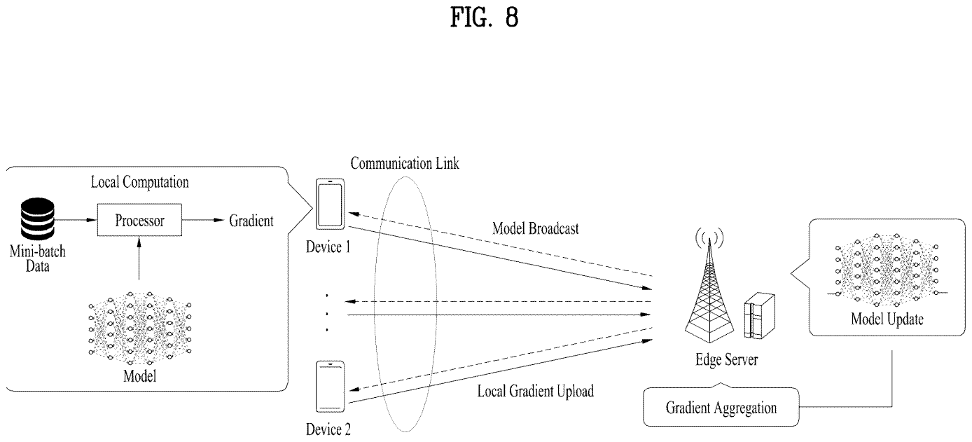

FIG. 8 illustrates an exemplary FEEL system. For simplicity, it is assumed that an edge server has L antennas and there are K edge devices each having a single antenna in FIG. 8. A set of device indexes may be denoted as [symbol] ={1, 2, . . . , K}.

A FEEL framework was first developed by Google and has the following three characteristics: 1) learning on distributed data, 2) exploiting on-device computation resources, and 3) preserving user-data privacy. The FEEL framework operates in multiple rounds, each having four phases. Phase 1) An edge server broadcasts an AI model to edge devices that will participate in learning. Phase 2) Active edge devices calculate gradients using (scheduled) local data sets. Phase 3) Those edge devices transmit their learned local gradients to the edge server. Phase 4) The edge server updates a global model by aggregating the local gradients. From the edge devices' perspective, phase 2) and phase 3) incur time and energy consumption. Since the disclosure focuses on edge devices, issues of a local computation and local gradient upload process are addressed.

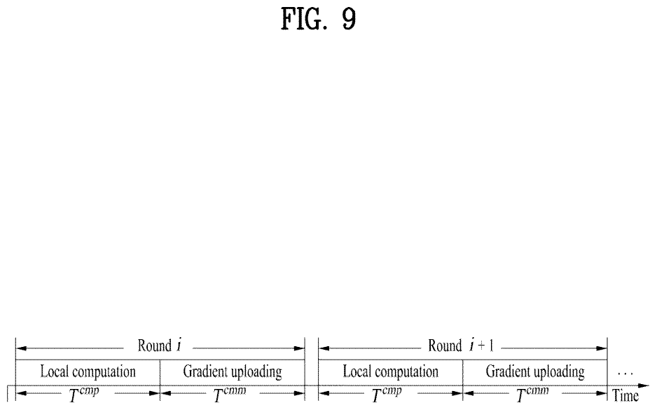

FIG. 9 illustrates a round for a FEEL operation. Referring to FIG. 9, an active edge device may generate a local gradient and transmit the local gradient to the edge server in each round. The round may be divided into two phases: (1) local computation and (2) gradient uploading. Let time periods for local computation and gradient uploading in the round be denoted by T^{cmp} and T^{cmp}, respectively. The 2-phase operations of all active edge devices should be performed in synchronization with each other and satisfy the following constraint.

$$0 \leq {t}_{k}^{cmp} \leq {T}^{cmp} and 0 \leq {t}_{k}^{cmm} \leq {T}^{cmm} \qquad [ Equation 1 ]$$

Herein,

$${t}_{k}^{cmp} and {t}_{k}^{c m m}$$

represent a local computation time and a gradient transmission time of a k^{th} edge device in each round.

Federated learning will be described in more detail. In the disclosure, standard federated learning is considered. First, the following definitions are used for a device k.
w∈ [symbol] : An AI-model to be trained. It may be defined as a parametric vector of size q.
{(xⱼ,yⱼ)}: A local dataset. Here, xⱼ and yⱼ are a j^{th} local raw data sample and label.
[symbol] : Local data distribution
[symbol] (w;(xⱼ,yⱼ): A sample-wise loss function (meaning an estimation error between a data sample xⱼ and a label yⱼ when performing a task using a model w).

FEEL aims to minimize a global loss function F(w), which may be expressed as follows.

$$F ( w ) = \frac{1}{K} {\sum }_{k = 1}^{K} {F}_{k} ( w ) \qquad [ Equation 2 ]$$

Herein, Fₖ(w) is a local loss function for an expected risk at device k and may be defined as follows.

$${F}_{k} ( w ) = {( x , y ) ∼ {𝒟}_{k}}_{} [ {ℓ}_{k} ( w ; ( x , y ) ) ] \qquad [ Equation 4 ]$$

During the FEEL operation, each device obtains gradients (hereinafter, local gradients) that minimize the local loss function contributing to the global loss function for the model w, and transmits the local gradients to the edge server, in each round. The edge server may aggregate local gradients received from the devices to obtain global gradients and update the model w. In an i^{th} round, the edge server may transmit a current model w⁽ⁱ⁾ to the devices.

Due to a radio fading channel, only some of all devices may be selected to participate in the learning in each round. For example, in the i^{th} round, only a subset [symbol] ⊆ [symbol] with size M⁽ⁱ⁾=| [symbol] | out of a total set of devices may be selected to participate in learning. Each selected device k∈ [symbol] may obtain a gradient that minimizes the local loss function by performing random sampling according to a local data distribution [symbol] . Let a sampled mini-batch local data set be [symbol] with size

$${b}_{k}^{( i )} = \vert {ℬ}_{k}^{( i )} \vert .$$

A gradient obtained by the k^{th} device using mini-batch data in the i^{th} round is given by

$${g}_{k}^{( i )} = \frac{1}{{b}_{k}^{( i )}} {\sum }_{( {x}_{j} , {y}_{j} ) ∈ {ℬ}_{k}^{( i )}} ∇ {ℓ}_{k} ( {w}^{( i )} ; ( {x}_{j} , {y}_{j} ) ) \qquad [ Equation 5 ]$$

After calculating the local gradient, the edge device may transmit the information to the edge server. The edge server may receive a local gradient from each active device and determine a global gradient as follows. Since the local gradient obtained by each active device has a different reliability according to a mini-batch size in the local gradient computation, the global gradient is determined by a weighted average that reflects the different reliabilities. In this case, although each active device is responsible for determining a mini-batch size, the edge server may also identify the mini-batch size from channel information between each active device and the edge server, without additional information.

$${g}^{( i )} = \frac{1}{{\sum }_{k ∈ {ℳ}^{( i )}} {b}_{k}^{( i )}} {\sum }_{k ∈ {ℳ}^{( i )}} {b}_{k}^{( i )} {g}_{k}^{( i )} \qquad [ Equation 6 ]$$

The global model update may be performed using stochastic gradient descent (SGD) as follows.

$${w}^{( i + 1 )} = {w}^{( i )} - η {g}^{( i )} \qquad [ Equation 7 ]$$

Herein, η is a learning rate, which may have a value of 0 to 1. The above process may be repeated until the model converges.

Now, local computation will be described in more detail. The energy consumption of local computation is determined by two factors. One of the factors is a mini-batch size, and the other is a clock frequency fₖ of a processor. Let per-sample workload for obtaining a local gradient be denoted by W. The per-sample workload is defined as the number of floating point operations (FLOPs) required to process each data sample. When it is assumed that model training is the same on each device, it may be assumed that all per-sample computational overheads are the same. Therefore, the workload of device k in the i^{th} round may be defined as

$${b}_{k}^{( i )} \times W$$

where

$${b}_{k}^{( i )}$$

is a mini-batch size of device k in the i^{th} round.

Meanwhile, the clock frequency

$${f}_{k}^{( i )}$$

of the processor is measured in cycles per second. The computational speed of the processor is measured in FLOPs per second, and is therefore

$${f}_{k}^{( i )} \times {N}_{k}^{FLOP} \cdot {N}_{k}^{FLOP}$$

is the computational capacity (available # of FLOPs per cycle). For a given workload and computational speed, the local computation time of device k is given by

$${t}_{k}^{cmp ( i )} = \frac{{b}_{k}^{( i )} W}{{f}_{k}^{( i )} {N}_{k}^{FLOP}} \qquad [ Equation 8 ]$$

The power consumption P of a CMOS-based processor is proportional to the square V² of a supply voltage and a clock frequency f (P∝V²f). For a low-voltage CMOS circuit, the clock frequency is proportional to the supply voltage V (f∝V). As a result, the power consumption of the processor may be defined as a function of the clock frequency, P=Cf³. Herein, C [Watt/(cycle/s)³] is a constant term determined by a chip structure. Accordingly, the power consumption of the processor of device k in the i^{th} round may be given as follows.

$${P}_{k}^{cmp ( i )} = {{C}_{k} ( {f}_{k}^{( i )} )}^{3} \qquad [ Equation 9 ]$$

The energy consumption device k in the i^{th} round may be defined as

$${E}_{k}^{cmp ( i )} = {P}_{k}^{cmp ( i )} \times {t}_{k}^{cmp ( i )} = \frac{{C}_{k}}{{N}_{k}^{FLOP}} {b}_{k}^{( i )} {W ( {f}_{k}^{( i )} )}^{2} \qquad [ Equation 10 ]$$

Next, gradient uploading (i.e., wireless transmission) will be described in more detail. It is assumed that device k uploads in the i^{th} round. It is assumed that each gradient coefficient is quantized in Q bits. In this case, a q-dimensional AI model incurs a communication overhead of q·Q bits. It is assumed that a UL bandwidth is divided into K B-Hz narrow subbands and the narrow subbands are orthogonally allocated to the respective devices. When the server receives the local gradient of each device, the transmission rate of device k in the i^{th} round may be defined as follows.

$${r}_{k}^{( i )} = B \cdot {log}_{2} ( 1 + \frac{{‖ {h}_{k}^{( i )} ‖}^{2} {P}_{k}^{cmm ( i )}}{B \cdot {N}_{0}} ) \qquad [ Equation 11 ]$$

$${h}_{k}^{( i )} ∈$$

represents a channel vector,

$${P}_{k}^{cmm ( i )}$$

represents transmission power, N₀ represents an additive white Gaussian noise (AWGN) power spectral density, and B represents an allocated frequency band.

Transmission of q·Q bits should be supported in one round. Therefore, replacing

$${r}_{k}^{( i )}$$

with q·Q causes the following power limit.

$${P}_{k}^{cmm ( i )} = \frac{B \cdot {N}_{0}}{{‖ {h}_{k}^{( i )} ‖}^{2}} ( {2}^{\frac{q \cdot Q}{{Bf}_{k}^{cmm ( i )}}} - 1 ) \qquad [ Equation 12 ]$$

Accordingly, the transmission energy consumption may be given by

$${E}_{k}^{cmm ( i )} = {P}_{k}^{cmm ( i )} \times {t}_{k}^{cmm ( i )} = \frac{1}{{‖ {h}_{k}^{( i )} ‖}^{2}} φ ( {t}_{k}^{cmm ( i )} ) \qquad [ Equation 13 ]$$

Herein, a function φ(.) is

$$φ ( t ) = B \cdot {N}_{0} \cdot t ( {2}^{\frac{q \cdot Q}{Bt}} - 1 ) .$$

Traditional FEEL research has focused on radio resource management, such as AirComp or uploading frequency optimization which improves communication efficiency while speeding up learning. However, from an implementation perspective, the energy consumption of an edge device with a limited battery is also an important consideration.

Edge device scheduling and local computation control policies that enable efficient operation of a FEEL system in the presence of energy-constrained edge devices will be described/proposed below.

First, a device scheduling method proposed in the disclosure will be described.

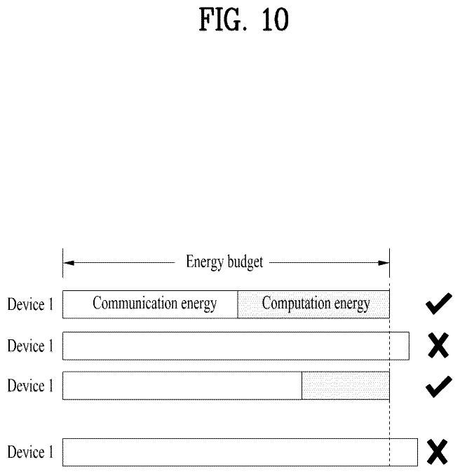

FIG. 10 illustrates exemplary energy budget-based device scheduling. When a device transmits a signal, required transmission energy E^{cmm} is a monotonically decreasing function of a transmission time (see Equation 13). That is, a maximum transmission period is required to minimize the energy of device k in the i^{th} round

$$( {t}_{k}^{cmm ( i )} = {T}^{cmm} ) .$$

Therefore, minimum transmission energy required for device k to transmit a signal in the i^{th} round may be defined as follows by replacing

$${t}_{k}^{cmm ( i )}$$

with T^{cmm} in Equation 13.

$${E}_{k}^{cmm ( i )} = \frac{1}{{‖ {h}_{k}^{( i )} ‖}^{2}} φ ( {T}^{cmm} ) \qquad [ Equation 14 ]$$

It may be noted from Equation 14 that the transmission energy consumption of each device is proportional to the inverse of a channel gain of the device. That is, a device with a good channel requires less energy than a device with a bad channel. Since the channel gain varies from round to round for each device, the communication energy required by each device varies. A channel gain/state may refer to a gain/state of a UL channel of each device. The channel gain/state may be estimated by the server based on a reference signal (e.g., a channel state information reference signal (CSI-RS) or a sounding reference signal (SRS)) transmitted by each device, although the disclosure is not limited to this. With the i^{th} round focused, an energy threshold (i.e., energy budget) E per device may be set. Accordingly, the sum of computation energy and communication energy of each device in each round may be limited not to exceed the energy threshold

$$\begin{matrix}{E}_{k}^{cmm ( i )} + \\ {E}_{k}^{cmm ( i )} \leq E ) .\end{matrix}$$

Thus, when the communication energy required in each round exceeds the energy budget, an energy outage event occurs at the corresponding device (e.g., device 2 or device K). Eventually, only devices with sufficiently good channels (e.g., device 1 and device 3) in the i^{th} round are selected/scheduled to participate in the learning. A sufficiently good channel may refer to, for example, a channel that satisfies

$$\begin{matrix}{E}_{k}^{cmm ( i )} ( {‖ {h}_{k}^{( i )} ‖}^{2} ) < E ( or \\ {‖ {h}_{k}^{( i )} ‖}^{2} > \frac{1}{E} φ ( {T}^{cmm} ) ) .\end{matrix}$$

The outage devices wait for the next round (e.g., device 2 and device K). Device selection/scheduling may be performed dynamically in each round by the server. For example, in each round, the server may select devices to participate in learning based on the energy budget and request that the devices report their learning results. For this purpose, the server may allocate radio resources to the devices to report their learning results. In another example, device selection/scheduling may be performed by each device on its own in each round. For this purpose, radio resources for reporting learning results may be semi-statically pre-allocated to each device. Then, when the communication energy required in each round does not exceed the energy budget, the device may use the pre-allocated radio resources to report a learning result for the round. On the contrary, when the communication energy required in each round exceeds the energy budget, the device may wait for the next round. When each device determines on its own whether to report a learning result, a UL channel gain/state may be transmitted to each device by the server or inferred based on a DL reference signal.

Next, local computation control proposed in the disclosure will be described. The computation energy budget of a k^{th} device in the i^{th} round is

$${E}_{k}^{cmp ( i )} = E - {E}_{k}^{cmm ( i )} .$$

The local computation factors of each device are a sampled mini-batch size and the clock frequency of the processor, which are optimized to maximize local gradient estimation. More specifically, increasing a local mini-batch size bx for model learning increases local energy consumption, although it helps to increase local gradient reliability.

Processing more samples under time constraints requires increasing the clock frequency of the processor, and the increase of the clock frequency boosts energy consumption. Therefore, the mini-batch size

$${b}_{k}^{( i )}$$

and the clock frequency

$${f}_{k}^{( i )}$$

need to be optimized to maximize the local gradient reliability under time/energy constraints. Since the local gradient reliability is proportional to the mini-batch size

$${b}_{k}^{( i )} ,$$

the objective problem may be formulated as follows.

$$[ Equation 15 ]$$

$$\begin{matrix}\begin{matrix}{max}_{\{ {b}_{k} , {f}_{k} \}} & {b}_{k}^{( i )} \\ s . t . & 0 < {b}_{k}^{( i )} {C}_{k} {W ( {f}_{k}^{( i )} )}^{2} \leq {E}_{k}^{cmp ( i )} ,\end{matrix} \\ 0 < \frac{{b}_{k}^{( i )} W}{{f}_{k}^{( i )}} \leq {T}^{cmp}\end{matrix} \qquad ( P 1 )$$

In (P1), an optimal batch size

$${\overline{b}}_{k}^{( i )}$$

and an optimal clock frequency

$${\overline{f}}_{k}^{( i )}$$

may be given as follows.

$${\overline{b}}_{k}^{( i )} = \frac{{N}_{k}^{FLOP}}{W} {( \frac{{{E}_{k}^{cmp ( i )} ( {T}^{cmp} )}^{2}}{{C}_{k}} )}^{\frac{1}{3}} and {\overline{f}}_{k}^{( i )} = {( \frac{{E}_{k}^{cmp ( i )}}{{C}_{k} {T}^{cmp}} )}^{\frac{1}{3}} \qquad [ Equation 16 ]$$

An exemplary process proposed in the disclosure is given as follows.

### Hyper-Parameters:

Computation time (one round): T^{cmp}
Transmission time (one round): T^{cmm}
Energy budget (one round): E
Computation coefficients: {Cₖ} and

$$\{ {N}_{k}^{F L O P} \}$$

Per-sample workload: W

### Federated Learning Procedure:

For round i=0, 1, 2, . . . , N−1:
The edge server broadcasts a model (e.g., convolutional neural network (CNN)) to the edge devices;
Each edge device may obtain

$$\{ {‖ {h}_{k}^{( i )} ‖}^{2} \}$$

by performing channel estimation;
For active edge device s,

$${ℳ}^{( i )} = \{ k ∈ 𝒦 : {‖ {h}_{k}^{( i )} ‖}^{2} > \frac{1}{E} φ ( {T}^{cmm} ) \} ;$$

Each edge device k∈ [symbol] may calculate a gradient estimate by processing

$$max \{ ⌊ {\overline{b}}_{k}^{( i )} ⌋ , 1 \}$$

data samples at the clock frequency

$${\overline{f}}_{k}^{( i )} .$$

The computation energy budget of device k may be given by

$${E}_{k}^{cmp ( i )} = E - \frac{1}{{‖ {h}_{k}^{( i )} ‖}^{2}} φ ( {T}^{cmm} ) ;$$

After the gradient calculation, the active devices may upload the gradient estimates

$$\{ {g}_{k}^{( i )} \}$$

to the edge server;
The edge server may calculate a global gradient estimate g⁽ⁱ⁾ by aggregating the local gradient estimates, and update the model based on w⁽ⁱ⁺¹⁾=w⁽ⁱ⁾−ηg⁽ⁱ⁾.

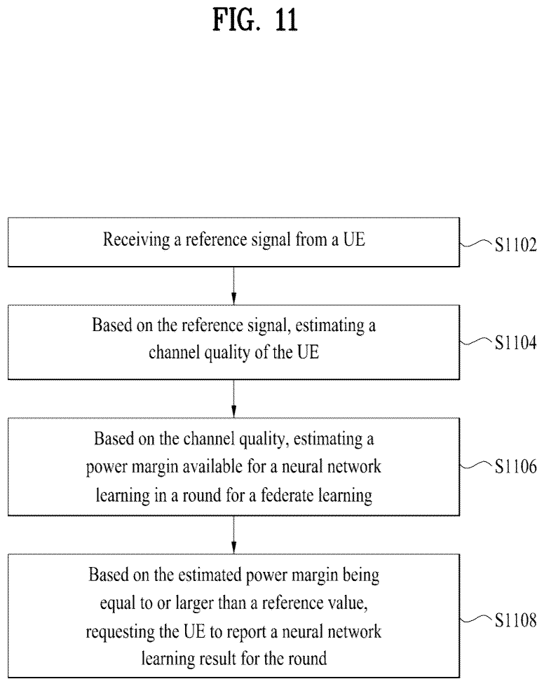

FIG. 11 illustrates a signal transmission and reception process according to an embodiment of the disclosure.

Referring to FIG. 11, an edge server (e.g., BS) may receive a reference signal from an edge device (e.g., UE) (S1102), and estimate channel quality of the UE based on the reference signal (S1104). The BS may estimate a power margin available for a neural network learning at the UE within a round for federated learning, based on the channel quality of the UE (S1106). Based on the estimated power margin being equal to or greater than a threshold, the BS may request a neural network learning result for the round from the UE. On the contrary, based on the estimated power margin being less than the threshold, the BS may skip requesting, to the UE, a result of the neural network learning for the round. The round for federated learning may include a computation period for the result of the neural network learning and a communication period for reporting the result of the neural network learning. The power margin may further be determined based on (1) an energy budget for the round and (2) the length of the communication period in the round. Further, a mini-batch size related to the result of the neural network learning may be determined based on the length of the computation period in the round and a per-sample workload.

The various descriptions, functions, procedures, proposals, methods, and/or operational flowcharts proposals of the disclosure described above in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

In the disclosure, the at least one memory (e.g., 104 or 204) may store instructions or programs, and the instructions or programs may cause, when executed, at least one processor operably connected to the at least one memory to perform operations according to some embodiments or implementations of the disclosure.

In the disclosure, a computer readable storage medium may store at least one instruction or program, and the at least one instruction or program may cause, when executed by at least one processor, the at least one processor to perform operations according to some embodiments or implementations of the disclosure.

In the disclosure, a computer program may be recorded in at least one computer-readable (non-volatile) storage medium, and may include a program code that causes (at least one processor) to perform an operation when being executed according to some embodiments or implements of the disclosure. The computer program may be provided in the form of a computer program product. The computer program product may include at least one computer readable (non-volatile) storage medium, and the computer readable storage medium may include a program code that causes (at least one processor) to perform an operation when being executed according to some embodiments or implements of the disclosure.

In the disclosure, a processing device or apparatus may include at least one processor, and at least one computer memory operably connected to the at least one processor. The at least one computer memory may store instructions or programs, and the instructions or programs may cause, when executed, the at least one processor operably connected to the at least one memory to perform operations according to some embodiments or implementations of the disclosure.

A communication device of the disclosure includes at least one processor; and at least one computer memory operably connected to the at least one processor and configured to store instructions for causing, when executed, the at least one processor to perform operations according to example(s) of the disclosure described later.

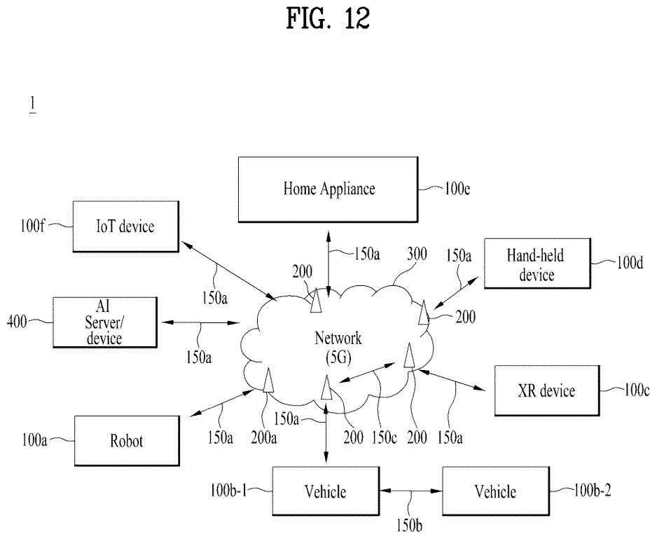

FIG. 12 illustrates a communication system 1 applied to the disclosure.

Referring to FIG. 12, a communication system 1 applied to the disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the disclosure.

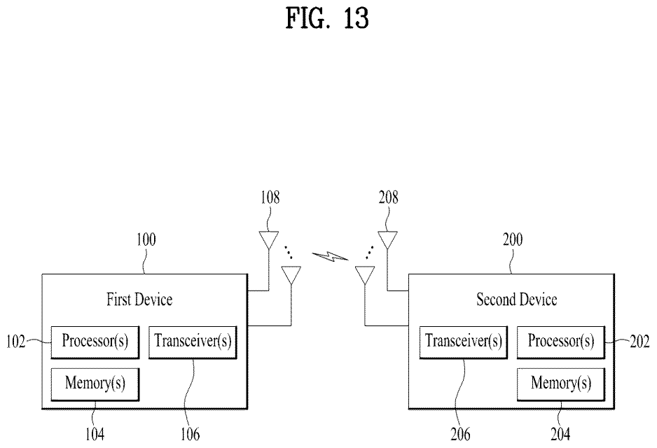

FIG. 13 illustrates wireless devices applicable to the disclosure.

Referring to FIG. 13, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 12.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

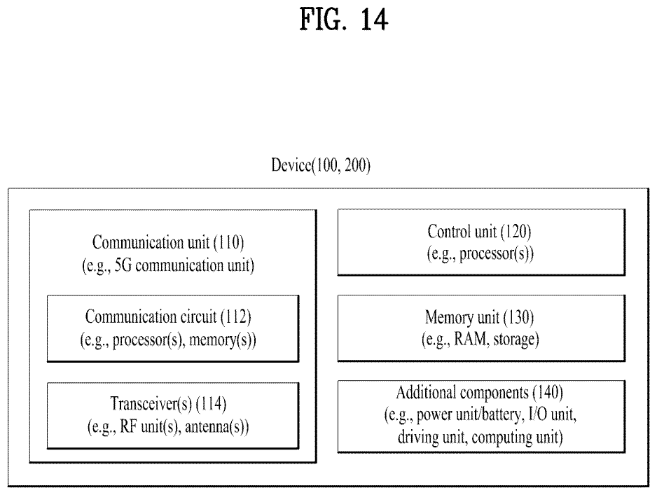

FIG. 14 illustrates another example of a wireless device applied to the disclosure. The wireless device may be implemented in various forms according to a use-case/service (refer to FIG. 12).

Referring to FIG. 14, wireless devices 100 and 200 may correspond to the wireless devices 100 and 200 of FIG. 13 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 13. For example, the transceiver(s) 114 may include the one or more transceivers 106 and 206 and/or the one or more antennas 108 and 208 of FIG. 13. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 12), the vehicles (100b-1 and 100b-2 of FIG. 12), the XR device (100c of FIG. 12), the hand-held device (100d of FIG. 12), the home appliance (100e of FIG. 12), the IoT device (100f of FIG. 12), a digital broadcast terminal, a hologram device, a public safety device, an MTC device, a medicine device, a fintech device (or a finance device), a security device, a climate/environment device, the AI server/device (400 of FIG. 12), the BSs (200 of FIG. 12), a network node, etc. The wireless device may be used in a mobile or fixed place according to a use-example/service.

In FIG. 14, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

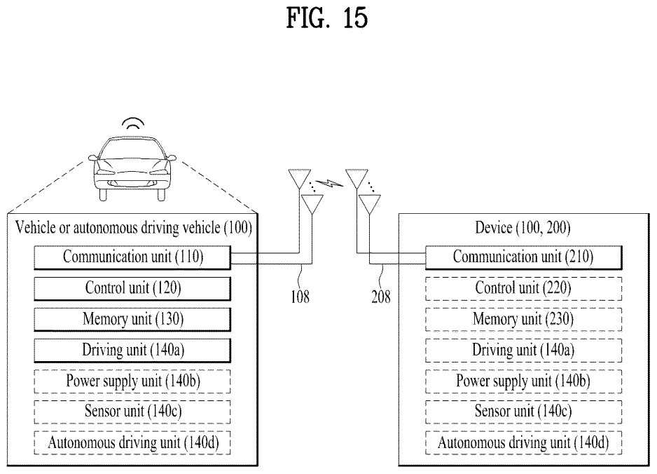

FIG. 15 illustrates a vehicle or an autonomous driving vehicle applied to the disclosure. The vehicle or autonomous driving vehicle may be implemented by a mobile robot, a car, a train, a manned/unmanned Aerial Vehicle (AV), a ship, etc.

Referring to FIG. 15, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 14, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the disclosure in prescribed forms. And, the respective elements or features may be considered as selective unless they are explicitly mentioned. Each of the elements or features may be implemented in a form failing to be combined with other elements or features. Moreover, it is able to implement an embodiment of the disclosure by combining elements and/or features together in part. A sequence of operations explained for each embodiment of the disclosure may be modified. Some configurations or features of one embodiment may be included in another embodiment or may be substituted for corresponding configurations or features of another embodiment. And, it is apparently understandable that an embodiment is configured by combining claims failing to have relation of explicit citation in the appended claims together or may be included as new claims by amendment after filing an application.

Those skilled in the art will appreciate that the disclosure may be carried out in other specific ways than those set forth herein without departing from the spirit and essential characteristics of the disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The disclosure is applicable to UEs. BSs or other apparatuses of a wireless mobile communication system.

What is claimed is:

1. A method of receiving a signal by a base station (BS) in a wireless communication system, the method comprising:
receiving a reference signal from a user equipment (UE);
estimating channel quality of the UE based on the reference signal;
based on the channel quality of the UE, estimating a power margin available for a neural network learning at the UE within a round for federated learning; and
based on the estimated power margin being equal to or greater than a threshold, requesting, to the UE, a result of the neural network learning for the round,
wherein the round includes a computation period for the result of the neural network learning and a communication period for reporting the result of the neural network learning.

2. The method of claim 1, wherein the power margin is further determined based on (1) an energy budget for the round and (2) a length of the communication period in the round.

3. The method of claim 1, wherein a mini-batch size related to the result of the neural network learning is determined based on a length of the computation period in the round and a per-sample workload.

4. The method of claim 1, wherein requesting, to the UE, the result of the neural network learning for the round is skipped based on the estimated power margin being less than the threshold.

5. A base station (BS) used in a wireless communication system, the BS comprising:
at least one radio frequency (RF) unit;
at least one processor; and
at least one computer memory operably connected to the at least one processor, and when executed, causing the at least one processor to perform operations,
wherein the operations include:
receiving a reference signal from a user equipment (UE);
estimating channel quality of the UE based on the reference signal;
based on the channel quality of the UE, estimating a power margin available for a neural network learning at the UE within a round for federated learning; and
based on the estimated power margin being equal to or greater than a threshold, requesting, to the UE, a result of the neural network learning for the round, and
wherein the round includes a computation period for the result of the neural network learning and a communication period for reporting the result of the neural network learning.

6. The BS of claim 5, wherein the power margin is further determined based on (1) an energy budget for the round and (2) a length of the communication period in the round.

7. The BS of claim 5, wherein a mini-batch size related to the result of the neural network learning is determined based on a length of the computation period in the round and a per-sample workload.

8. The BS of claim 5, wherein requesting, to the UE, a result of the neural network learning for the round is skipped based on the estimated power margin being less than the threshold.

9. An apparatus used in a base station (BS), the apparatus comprising:
at least one processor; and
at least one computer memory operably connected to the at least one processor, and when executed, causing the at least one processor to perform operations,
wherein the operations include:
receiving a reference signal from a user equipment (UE);
estimating channel quality of the UE based on the reference signal;
based on the channel quality of the UE, estimating a power margin available for a neural network learning at the UE within a round for federated learning; and
based on the estimated power margin being equal to or greater than a threshold, requesting, to the UE, a result of the neural network learning for the round, and
wherein the round includes a computation period for the result of the neural network learning and a communication period for reporting the result of the neural network learning.

10. The apparatus of claim 9, wherein the power margin is further determined based on (1) an energy budget for the round and (2) a length of the communication period in the round.

11. The apparatus of claim 9, wherein a mini-batch size related to the result of the neural network learning is determined based on a length of the computation period in the round and a per-sample workload.

12. The apparatus of claim 9, wherein requesting, to the UE, the result of the neural network learning for the round is skipped based on the estimated power margin being less than the threshold.

13. A computer-readable storage medium including at least one computer program which when executed, causes at least one processor to perform operations,
wherein the operations include:
receiving a reference signal from a user equipment (UE);
estimating channel quality of the UE based on the reference signal;
based on the channel quality of the UE, estimating a power margin available for a neural network learning at the UE within a round for federated learning; and
based on the estimated power margin being equal to or greater than a threshold, requesting, to the UE, a result of the neural network learning for the round, and
wherein the round includes a computation period for the result of the neural network learning and a communication period for reporting the result of the neural network learning.

14. The computer-readable storage medium 13, wherein the power margin is further determined based on (1) an energy budget for the round and (2) a length of the communication period in the round.

15. The computer-readable storage medium 13, wherein a mini-batch size related to the result of the neural network learning is determined based on a length of the computation period in the round and a per-sample workload.

16. The computer-readable storage medium 13, wherein requesting, to the UE, the result of the neural network learning for the round is skipped based on the estimated power margin being less than the threshold.
